(19) United States
(12) Patent Application Publication
(10) Pub. No.: US 2013/0345338 A1
(43) Pub. Date: Dec. 26, 2013

(54) SYSTEM AND METHOD FOR TREATING AGRICULTURAL SETTINGS

(71) Applicants: Michael R. Hoggatt, Naples, FL (US); James Latham Zwynenburg, Queensbury, NY (US); Roger W. Faulkner, Melrose, MA (US)

(72) Inventors: Michael R. Hoggatt, Naples, FL (US); James Latham Zwynenburg, Queensbury, NY (US); Roger W. Faulkner, Melrose, MA (US)

(21) Appl. No.: 13/532,620

(22) Filed: Jun. 25, 2012

(51) Int. Cl. C08L 63/00

(52) U.S. Cl. 523/451

(57) ABSTRACT

The treatment of an agricultural setting may be implemented by applying an adhesive using a pump sprayer. The agricultural setting may include mulch, pine straw, wood chips, and other materials used in landscaping. The adhesive may be used to keep the agricultural setting in place. For example, the adhesive may keep mulch from moving in heavy winds or during a storm.

### BRIEF DESCRIPTION OF THE DRAWINGS

In the drawings,

FIG. 1 is a schematic representation of the system of the preferred embodiment.

FIG. 2 is a schematic representation of the system of the preferred embodiment, wherein the sprayer is a pump sprayer.

FIG. 3 is a flowchart representation of the method of the preferred embodiment.

FIG. 4 is a flowchart representation of the method of an alternative embodiment wherein additives are added to the polymer dispersion.

### DETAILED DESCRIPTION

The treatment of an agricultural setting may be implemented by applying an adhesive using a pump sprayer. Preferably, the agricultural setting may include mulch, pine straw, wood chips, and other materials used in landscaping. The adhesive may be used to keep the agricultural setting in place. For example, the adhesive may keep mulch from moving in heavy winds or during a storm.

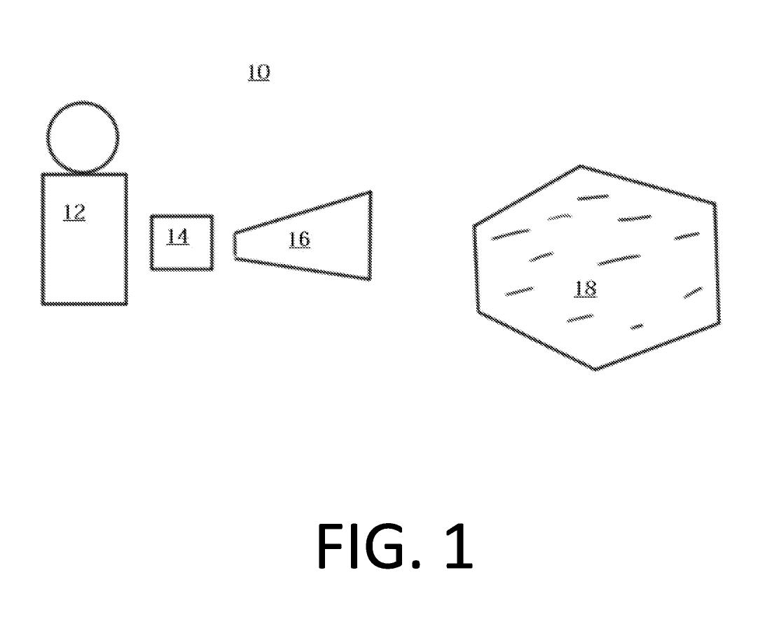

Referring to FIG. 1, a schematic diagram of a system 10 is shown. The system 10 may include a user 12, a sprayer 14, an adhesive spray 16, and an agricultural setting 18. The sprayer 14 may be any general compressed air sprayer. The adhesive spray 14 may be any general adhesive that comprises an aqueous polymer dispersion. In a preferred embodiment, the aqueous polymer dispersion may form a film upon drying and may be dilutable by water in its liquid form. The adhesive spray 14 is preferably adapted to be distributed by any general sprayer, including the sprayer 14. The agricultural setting 18 is preferably any material used for landscaping.

To treat the agricultural setting 18, the user 12 may fill the sprayer 14 with the adhesive spray 16. Generally, the adhesive spray 16 may comprise an aqueous polymer dispersion prior to application. The user 12 may then apply the adhesive spray 16 to the agricultural setting 18. The sprayer 14 may evenly distribute the adhesive spray 16 to those areas of the agricultural setting 18 that need treating.

Depending on the area being treated, the user 12 may alter the amount of adhesive spray 16 being distributed by the sprayer 14. For instance, if the user 12 is treating a small flower bed, the sprayer 14 may be altered so as to only distribute a small spray pattern of the adhesive spray 16. If the user 12 is treating a large area of pine straw, the sprayer 14 may be altered to distribute the maximum spray pattern of the adhesive spray 16.

The adhesive spray 16 may give a treated area of the agricultural setting 18 the ability to withstand outside forces, which can lead to the breakdown and separation of the untreated agricultural setting. The adhesive spray 16 may be particularly useful on a perimeter of landscaped areas. For instance, mulch may be in close proximity to the perimeter or in contact with hard surface such as curbs, sidewalks, parking areas, streets, etc. This type of agricultural setting would be highly susceptible to outside forces causing breakdown and separation.

A heavy rain or a drainage area may also be particularly harmful to an untreated agricultural setting. For example, untreated mulch subjected to heavy rain will break apart, and in the case of flowing water, will wash away. Another adverse effect is that some types of mulch may bleed on a porous surface and leave an unsightly stain.

After application, the adhesive spray 16 needs time to cure, during which time the spray dries out until the polymeric latex droplets in the aqueous dispersion are forced into contact, as the water between the latex droplets evaporates. The drying can occur at any temperature, but the latex droplets can only flow together into a continuous adhesive film if the polymer is above its glass transition. Pure polyvinylacetate latex can only form a film above 15 degrees Celsius, but various compositions based on polyvinylacetate latex with added coalescing solvents and/or plasticizers can be formulated to form films at temperatures down to zero degrees Celsius. The process of curing may vary in time and depend on the composition of the adhesive and/or the weather conditions. For instance, in dry climates the adhesive spray 16 will cure faster than in cold, wet climates. In one variation, the adhesive sprayed agricultural setting 18 may be heat treated to cure at an environmental temperature where the adhesive spray would not cure without being heated up.

In one embodiment, the adhesive spray 16 may include polyvinylacetate. In general, polyvinylacetate that is dispersed in water in the form of small latex particles is preferably used. In some applications, wetting agents and defoamers may be added to the formulation to increase wetting and to prevent foam formation during mixing, spraying, and or transportation of the adhesive.

After the adhesive spray 16 has been applied, and curing has been completed, the adhesive spray coating 16 on the mulch, and the cured adhesive spray coated mulch 18 can no longer be washed away by water short of a torrential current as might occur in a major flood. The cured adhesive spray coated mulch 18 preferably remains gas and liquid permeable.

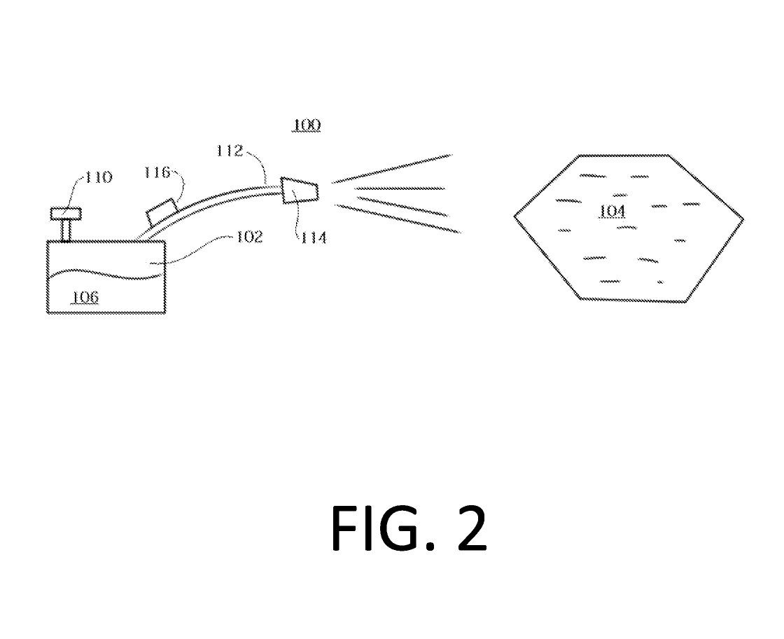

Referring to FIG. 2, a schematic diagram of a system 100 is shown. The system 100 may include a pump sprayer 102 and an agricultural setting 104. The pump sprayer 102 may be used to distribute an aqueous polymer dispersion 106 to the agricultural setting 104.

The pump sprayer 102 may be any general compressed air sprayer that may employ a manually operated air pump used for dispensing fluids. In one variation, the pump sprayer 102 may be a compressed air sprayer of the design used for dispensing fluids such as insecticides, herbicides, and sealants. Such sprayers normally include a specially designed container, tank or bottle which serves both to hold the fluid to be dispensed and to act as a pressure vessel (e.g., the pressure source for the liquid).

The pump sprayer 102 preferably has a container 108, a manual pump 110, a hose 112, and a nozzle 114. The manual pump 110 may be connected to the container 108. The manual pump 110 may be used to generate pressure in the container 108.

In operation of the pump sprayer 102, the manual pump 110 may pump air from outside the container 108 to inside the container 108. Initially, a liquid and any air in the container 108 may be at an ambient pressure. As air is pumped into the container 108, the air in the container may become compressed. The compressed air may act as a spring on the liquid and provide a pressure source for discharging the liquid from the container 108.

The hose 112 may be connected to the container 108. The nozzle 114 may be connected to the hose 112. In one embodiment, the hose 112 may have a release valve 116 attached. The release valve 116, or trigger, may release liquid in the container 108 to equalize the pressure generated by the manual pump 110. For example, escaping air may pressurize the inside of the container 108, which may force a liquid up an outlet tube that may be attached to the hose 112 leading to the nozzle 114. When the release valve 116, the pressurized liquid may spray out of the nozzle 114.

The aqueous polymer dispersion 106 is preferably an adhesive. Preferably, the adhesive 106 is environmentally safe for plants, animals, and humans. The adhesive 106 may, however, have any suitable environmental properties so as to effectively adhere the agricultural setting 104. The adhesive 106 is preferably an aqueous polymer dispersion such as a polymer latex which is water dilutable before application, but when the adhesive 106 is cured, the adhesive 106 preferably becomes a water insoluble polymer film. The insoluble polymer film preferably adheres mulch particles together.

In one embodiment, before the adhesive 106 is filled into the container 108, the adhesive 106 is preferably diluted by adding water. The diluted adhesive 106 may form an aqueous polymer dispersion. Preferably, the aqueous polymer dispersion 106 has a polymeric content between 8-16% by weight. Other polymeric content weights may be used. In one variation, the aqueous polymer dispersion 106 may be a polyvinylacetate based adhesive. The polyvinylacetate polymer dispersion 106 may be of such consistency that the pump sprayer 102 may be able to spray the polymer dispersion.

The preferred liquid adhesive composition is a liquid that is water dilutable before application that then becomes water insoluble when cured.

Depending on the agricultural setting 104, the adhesive 106 may be altered to meet a specific need. For instance, in humid or wet conditions, the adhesive 106 is preferably sprayed at a higher polymer weight fraction so that the adhesive 106 may cure in less time. In dry climates and conditions, the adhesive 106 is preferably diluted to a greater extent, and sprayed at lower polymer weight fraction. For example, when the agricultural setting 104 comprises mulch, an aqueous latex adhesive with lower polymer weight allows sufficient time for the aqueous latex adhesive to wet out the mulch and soak into the surface of the mulch particles enough to establish a good mechanical bond between the mulch and the polymer film. In cold conditions, volatile or non-volatile plasticizers may be used to reduce the minimum film forming temperature (MFFT) so that the adhesive 106 can cure at ambient temperatures. Under high intensity ultraviolet light exposure conditions, UV radiation absorbing and/or UV-protective additives may be used. Examples of UV absorbing additives include organic UV-absorbing chemicals such as cinnamates or inorganic colloids such as submicron zinc oxide, titanium dioxide, or iron oxide particles. Examples of UV-protective additives include hindered amine light stabilizers.

In a preferred embodiment, a user may treat the agricultural setting 104 with the adhesive 106. The adhesive 106 is preferably an aqueous polyvinylacetate polymer dispersion. Prior to treating the agricultural setting 104, the user may fill the container 108 with the polyvinylacetate polymer dispersion 106. Using the manual pump 110, the user may generate pressure in the container 108 sufficient to distribute the polyvinylacetate polymer dispersion 106.

After creating sufficient pressure, the user may distribute the polyvinylacetate polymer dispersion 106 using the hose 112. To release the pressure in the container 108, the user preferably depresses the release valve 116. While the release valve 116 is depressed, the polyvinylacetate polymer dispersion 106 may be distributed evenly by the nozzle 114.

The agricultural setting 104 is preferably one of several different landscaping materials. In one variation, a user may distribute the polyvinylacetate polymer dispersion 106 onto a bed of mulch, which could be pieces of bark or pine straw, for example. Landscaping materials may also be comprised of small stones, rock chips, or other inorganic materials. Landscaping materials may also be comprised of synthetic materials such as rubber pellets or any other type of synthetic landscaping materials. Synthetic materials tend to be used in areas around swimming pools or playgrounds where people might walk bare foot or tend to fall on the ground while playing.

After depositing the polyvinylacetate polymer dispersion 106 onto the agricultural setting 104, the polyvinylacetate polymer dispersion 106 preferably forms a film which coats the landscaping materials and bonds them together. To ensure the polymer dispersion 106 forms a continuous film, the polymer dispersion 106 must dry out at a temperature above the glass transition temperature of the polymer droplets so that the droplets flow together to form a polymer film; this is the state that is cured as the term “cured” is used herein. Various naturally occurring oils such as citronella and eucalyptus oil have been found to be effective for reducing the glass transition temperature down to as low as seven degrees Celsius, while still producing strong adhesive films. The polyvinylacetate polymer dispersion 106 may preferably remain gas permeable and liquid permeable after curing.

The amount of time to cure the polyvinylacetate polymer dispersion 106 may vary. In one variation, the adhesive 106 preferably cures in 6 hours. In another variation, the polyvinylacetate polymer dispersion 106 may cure in 12 hours. In humid conditions, the polyvinylacetate polymer dispersion 106 may cure in 24 hours. The above mentioned cure times are for illustrative purposes only. The amount of time to cure may vary and depend on several factors.

The cured polyvinylacetate adhesive preferably remains flexible, yet strong enough to endure a significant amount of weight, such as the weight of individuals, garden tools, wheelbarrows, trimmers, etc. The flexibility and strength of the cured ground cover may allow for normal trimming, weeding, fertilization, etc. In another instance, trimmings, grass, leaves, and other debris from the surface of the adhered area can be removed with brooms, rakes, leaf blowers and/or water streams without disturbing the adhered area.

In one variation, mulch treated with the adhesive preferably does not experience a significant change in the original properties of the mulch. The adhesive preferably allows the color of the mulch to remain unchanged and may also enhance the ability of the mulch to retard weed growth.

In another embodiment, additives may be added to the adhesive polymer dispersion. For instance, weed control and/or fire retarding additives may be added to the adhesive polymer dispersion. By adding certain additives to the adhesive polymer dispersion, the adhesive polymer dispersion preferably extends the useful life of the agricultural setting.

For example, the adhesive polymer dispersion may contain herbicide, insect or rodent repelling chemicals, fertilizers, aromatic scent chemicals, etc. The additives may be combined with the adhesive before application or may be applied before the adhesive is applied. Depending on a particular need of the agricultural setting, a herbicide, pesticide, or coloring agent may be added to the adhesive polymer dispersion. The herbicide may be used to kill unwanted weeds and other undesirable plants. Preferably, the pesticide may be used to prevent, destroy, repel, or mitigate any unwanted pests.

In some instances, the agricultural setting 104 may have synthetic materials. For example, areas around swimming pools or playgrounds where people might walk bare foot or tend to fall on the ground while playing. These areas generally have rubber pellets or some other type of synthetic landscaping materials. The synthetic materials may be treated with the adhesive polymer dispersion.

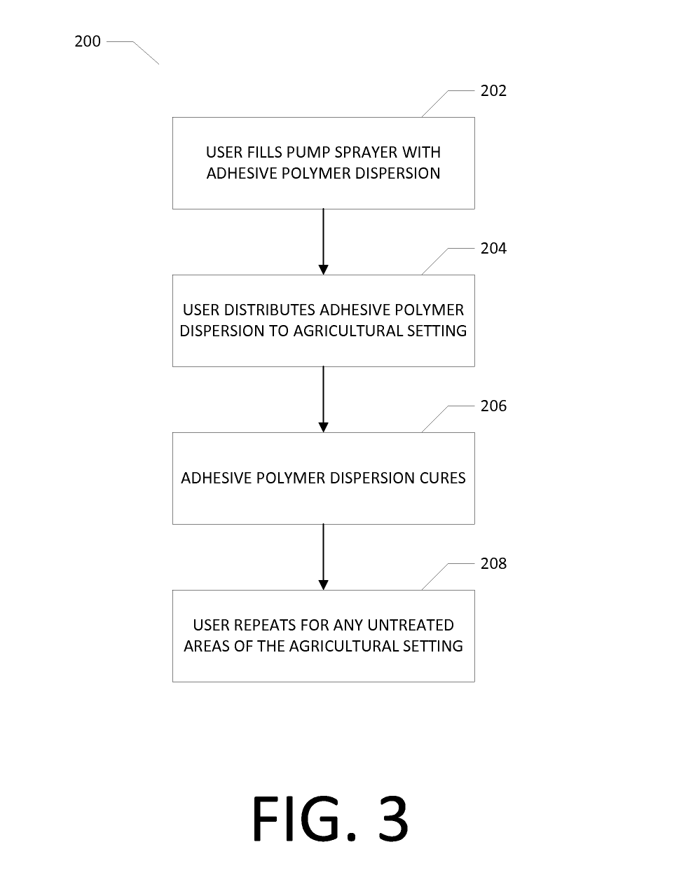

Referring to FIG. 3, a flowchart illustration of an embodiment 200 is shown. The embodiment 200 shows a method for treating an agricultural setting with an adhesive polymer dispersion to retain the ornamental integrity of the agricultural setting.

Many different treating methods and sequences may be used to treat an agricultural setting with the adhesive polymer dispersion.

A user may fill a pump sprayer in block 202. In one variation, the user may fill the pump sprayer with an adhesive polymer dispersion. Preferably, the adhesive polymer dispersion is dilutable in water. A specific dilution of the latex may be selected that is best adapted to the specific spraying conditions that pertain for a particular landscaping material and particular environmental conditions.

The user may distribute the adhesive polymer dispersion on an agricultural setting in block 204. The agricultural setting may be mulch, pine straw, wood chips, or any other material used in landscaping. The adhesive polymer dispersion may be used to hold treated areas of the agricultural setting in place.

After applying the adhesive polymer dispersion, the user may wait for the polymer dispersion to cure in block 206. After the polymer dispersion has cured, the adhesive polymer dispersion may be insoluble in water. It is important that block 206 occurs above the glass transition temperature of the polymeric phase. In general, the polymeric phase includes the polyvinylacetate, and any chemicals that are dissolved in the polyvinylacetate, including especially solvents or plasticizers that may lower the glass transition phase of the polyvinylacetate. Citronella and eucalyptus oil mixtures are particularly well suited as additives to polyvinylacetate latex to form adhesives 106 of the present invention, since they serve both to lower MFFT and act as a repellent for animals and insects.

In block 208, the user may repeat the method for any untreated sections of the agricultural setting, or parts of the agricultural setting that see unusual stress, such as areas that people tend to walk through as a shortcut, or drainage channels.

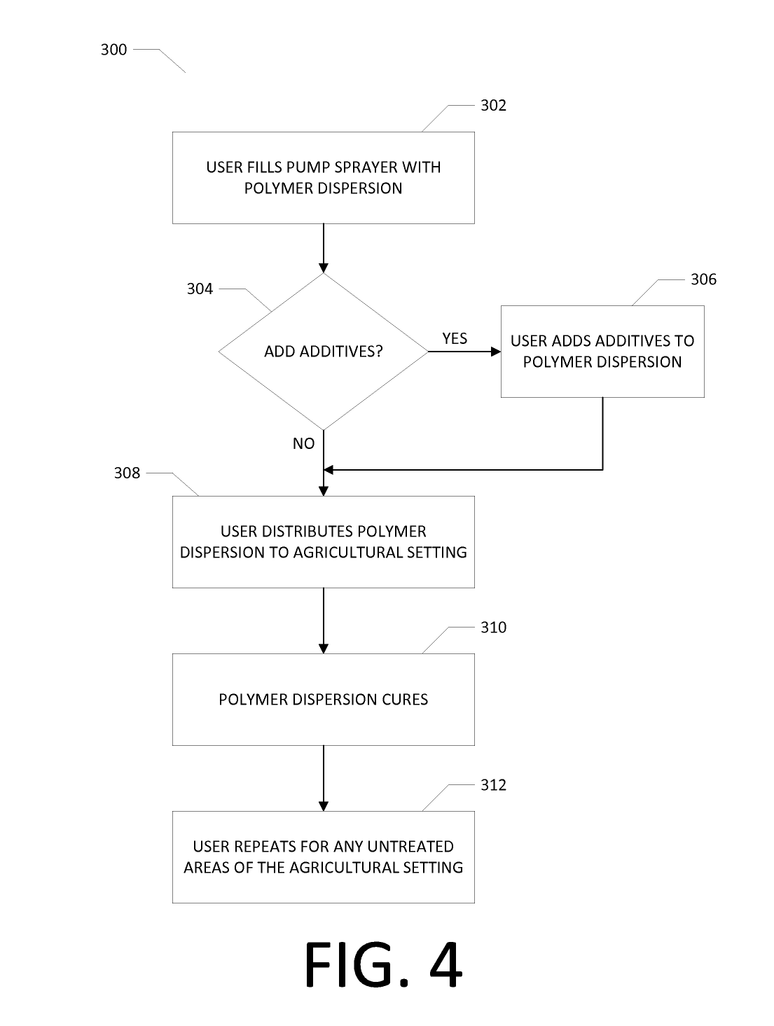

Referring to FIG. 4, a flowchart illustration of an embodiment 300 is shown. The embodiment 300 shows a method for treating an agricultural setting with a polyvinylacetate based polymer dispersion and other additives to retain the ornamental integrity of the agricultural setting.

Many different treating methods and sequences may be used to treat an agricultural setting with the polyvinylacetate based polymer dispersion, which may include other additives to aid the agricultural setting.

A user may fill a pump sprayer in block 302. In one example, the user may fill the pump sprayer with a polyvinylacetate based polymer dispersion. Generally, the polymer dispersion may be an aqueous polymer dispersion made of polyvinylacetate and other compounds.

The user may wish to add additives to the polyvinylacetate based polymer dispersion. In block 304, the user may determine if additives are to be added. If the user the does not add any additives, the process may move to block 308.

The user may add additives in block 306. For example, the user may wish to add weed control products to the polyvinylacetate based polymer dispersion. In another example, a user may wish to add plasticizers or solvents to reduce the MFFT of the adhesive 106. In another example, a user may wish to add plant food or micronutrients to the polymer dispersion. Any combination of additives may be added in block 306 subject only to the requirement that additives must be added in a form and by a procedure that does not cause coagulation or destabilization of the polyvinylacetate latex to an unacceptable extent.

The user may apply the polymer dispersion on an agricultural setting in block 308. The agricultural setting may be mulch, pine straw, wood chips, or any other material used in landscaping. The polyvinylacetate based polymer dispersion may be used to hold treated areas of the agricultural setting in place.

After applying the polyvinylacetate based polymer dispersion, the user may wait for the polymer dispersion to cure in block 310. After the polymer dispersion has cured, the polyvinylacetate based polymer dispersion may be insoluble. It has been found to be useful to heat the landscaping material after application of the adhesive 106 to achieve a stronger bond. In one example, the heating may be accomplished with infrared lamps. In another example, heating may be accomplished simply by covering the adhesive sprayed landscaping material with a clear plastic film cover on a sunny day. The film will trap the sun's energy by the greenhouse effect, known as “solarization.” When solarization is extended over a week or more of sunny weather, weed seeds and roots in the soil can be killed, as well as nematodes and certain insect pests. Solarization or infrared heating allows the adhesive-treated landscaping material to become much warmer than it would have been the case without the clear film covering. This may result in a stronger bond, or alternatively may make it possible to form a strong polyvinylacetate-based film at a temperature below 15 degrees Celsius without using solvents or plasticizers.

In block 312, the agricultural setting may be treated a second time to treat areas that were not adequately treated on the first pass 308.

It will be apparent to those of ordinary skill in the art that the embodiments described herein, while illustrative, are not intended to so limit the invention or the scope of the appended claims. Those of ordinary skill will understand that various combinations or modifications of the embodiments presented herein may be made without departing from the spirit and scope of the present invention.

What is claimed is:

1. A solution applicator system for use in an agricultural setting, said system comprising:
a pump sprayer; and
a water-based adhesive solution distributed by said pump sprayer to said agricultural setting, said water-based adhesive being insoluble in water after curing.

2. The solution applicator system of claim 1, said agricultural setting being mulch.

3. The solution applicator system of claim 1, said agricultural setting being pine straw.

4. The solution applicator system of claim 1, said agricultural setting being wood chips.

5. The solution applicator system of claim 1, said pump sprayer adapted to handle corrosive materials.

6. The solution applicator system of claim 5, said water-based adhesive solution including at least one of:
a viscosity modifying additive;
a plasticizer;
a wetting agent; and
a fire retardant;

7. The solution applicator system of claim 5, said water-based adhesive solution including at least one of:
insect or rodent repelling chemicals;
fertilizers;
aromatic scent chemicals; and
a defoamer;

8. The solution applicator system of claim 5, said water-based adhesive solution including at least one of:
an emulsion-stabilizing water soluble polymer;
an ultraviolet radiation absorbing additive;
an ultraviolet protective additive;
a herbicide;
a pesticide; and
a coloring agent.

9. The solution applicator system of claim 1, said water-based adhesive comprising a polymer dispersion based on polyvinylacetate latex.

10. The solution applicator system of claim 9, said agricultural setting being heated above an environmental ambient temperature after said water-based adhesive is distributed to said agricultural setting.

11. The solution applicator system of claim 10, said agricultural setting being heated by a heat lamp.

12. The solution applicator system of claim 10, said agricultural setting being heated by a method comprising the steps of:
covering said agricultural setting with a clear plastic film; and
leaving said agricultural setting covered for a week.

13. A solution applicator system for use in an agricultural setting, said system comprising:
a pump sprayer; and
a polyvinylacetate polymer dispersion distributed by said pump sprayer to said agricultural setting, said polyvinylacetate polymer dispersion being insoluble in water after curing.

14. The solution applicator system of claim 13, said agricultural setting including at least one of:
mulch;
pine straw;
peat moss;
decorative gravel; and
wood chips.

15. The solution applicator system of claim 13, said agricultural setting including at least one of:
crushed stone;
driveway stone with dust or clay;
sand;
top soil; and
rubber granules.

16. The solution applicator system of claim 13, said pump sprayer adapted to handle corrosive materials.

17. The solution applicator system of claim 16, said polyvinylacetate polymer dispersion including at least one of:
a viscosity modifying additive;
a plasticizer;
a wetting agent; and
a fire retardant;

18. The solution applicator system of claim 16, said polyvinylacetate polymer dispersion including at least one of:
insect or rodent repelling chemicals;
fertilizers;
aromatic scent chemicals; and
a defoamer;

19. The solution applicator system of claim 16, said polyvinylacetate polymer dispersion including at least one of:
an emulsion-stabilizing water soluble polymer;
an ultraviolet radiation absorbing additive;
an ultraviolet protective additive;
a herbicide;
a pesticide; and
a coloring agent.
